(19) United States
(12) Patent Application Publication
(10) Pub. No.: US 2026/0018060 A1
(43) Pub. Date: Jan. 15, 2026

(54) LANE ALERT SYSTEM

(71) Applicant: Melodie Franklin, Norcross, GA (US)

(72) Inventor: Melodie Franklin, Norcross, GA (US)

(21) Appl. No.: 19/269,189

(22) Filed: Jul. 15, 2025

Related U.S. Application Data
(60) Provisional application No. 63/671,323, filed on Jul. 15, 2024.

(51) Int. Cl. G08G 1/16; B60Q 1/26; B60Q 1/38; B60R 1/12; B60W 30/18; B60W 50/14; B62D 15/02

(52) U.S. Cl. CPC G08G 1/167; B60Q 1/2665; B60Q 1/38; B60R 1/1207; B60W 30/18163; B62D 15/0255; B60W 50/14; B60W 2552/10; B60W 2554/4045; B60W 2556/10

(57) ABSTRACT

Methods, systems, and apparatus, including computer programs encoded on a computer storage medium, for lane alerts. Methods can include obtaining from a first sensor of a given vehicle, lane data specifying a lane of a multi-lane roadway that is occupied by the given vehicle. Vehicle passed data representing instances of the given vehicle being passed by other vehicles is obtained from a second sensor. Travel data indicating that the given vehicle traveled a specified distance is obtained. An alert is generated based on the lane data, the vehicle passed data, and the travel data. A lane change operation of the given vehicle is initiated based on the alert being generated.

### CLAIM OF PRIORITY

This application claims priority under to U.S. Provisional Application Ser. No. 63/671,323, filed on Jul. 15, 2024, the entire contents of which are hereby incorporated by reference.

### BACKGROUND

Jurisdictions (e.g., states, counties, cities, etc.) have been implementing various versions of a “Slow Poke Law” that requires vehicles to remain at least at the speed limit when the vehicle is in the farthest left lane, sometimes referred to as a designated passing lane in the United States. The general principle behind these types of laws is to have slower vehicles on the right, and faster vehicles on the left. For example, when slow drivers linger in the left lane of multi-lane roads in the United States, a driver of a vehicle may be inclined to pass on the right, causing confusion and disorganization that can lead to accidents and traffic congestion. Moreover, drivers who violate a designated passing lane slow poke law are often unaware of the traffic congestion or potential accidents they may create by lingering in the designated passing lane.

### SUMMARY

This specification describes technologies relating to methods, systems, and computer-readable storage media for implementing lane alerts. In general, one innovative aspect of the subject matter described in this specification can be embodied in methods that include the actions of obtaining, by one or more processors and from a first sensor of a given vehicle, lane data specifying a lane of a multi-lane roadway that is occupied by the given vehicle; obtaining, by the one or more processors and from a second sensor, vehicle passed data representing instances of the given vehicle being passed by other vehicles; obtaining, by the one or more processors, travel data indicating that the given vehicle traveled a specified distance; generating, by the one or more processors, an alert based on the lane data, the vehicle passed data, and the travel data; and initiating, by the one or more processors, a lane change operation of the given vehicle based on the alert being generated.

Other embodiments of this aspect include corresponding systems, apparatus, and computer programs, configured to perform the actions of the methods, encoded on computer storage devices.

These and other embodiments can each optionally include one or more of the following features. Implementations can include determining, based on the vehicle passed data, a number of the other vehicles that passed the given vehicle while the given vehicle traveled the specified distance, wherein generating the alert comprises generating the alert when the number of other vehicles that passed the given vehicle while the given vehicle traveled the specified distance meets a threshold number.

Determining the number of other vehicles that passed the given vehicle while the given vehicle traveled the specified distance can include obtaining blind spot data indicating that a blind spot monitoring system detected the other vehicles while the given vehicle traveled the specified distance; obtaining additional data indicating that the other vehicles moved from a back of the given vehicle to a front of the vehicle while the given vehicle traveled the specified distance; and determining the number of other vehicles that passed the given vehicle based on the blind spot data and the additional data.

Implementations can include determining, based on the lane data, that the given vehicle is traveling in a designated passing lane over the given distance, wherein generating the alert data comprises generating the alert data based on (i) the given vehicle traveling in the designated passing lane over the given distance, and (ii) the number of vehicles that passed the given vehicle over the given distance meeting the threshold number. Initiating the lane change operation of the given vehicle can include illuminating a lane change indicator on a mirror of the given vehicle. Initiating the lane change operation of the given vehicle can further include autonomously navigating the given vehicle to a different lane of the multi-lane roadway.

Implementations can include generating, in a memory device, an alert log indicative of how many alerts have been generated for the given vehicle; and determining, based on the alert log, an alert trend indicating whether a frequency of alerts generated for the given vehicle have increased, decreased, or remained constant.

Particular embodiments of the subject matter described in this specification can be implemented so as to realize one or more of the following advantages. The subject matter provides an implementation of a lane alert system that allows for the generation of more reliable and accurate reporting of improper lane usage based on various data types and sources. For example, the techniques discussed herein can determine whether a given vehicle is misusing a designated passing lane, inform the driver of the given vehicle of the improper usage, initiate a lane change operation, and/or report the improper lane usage to an enforcement authority. In this way, the techniques discuss herein can improve vehicle traffic safety and reduce traffic congestion, for example, by slower moving vehicles out of designated passing lanes, thereby leaving those designated passing lanes open for faster moving vehicles.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an illustration of an environment in which a lane alert system can be implemented.

FIG. 2 is an illustration of an example roadway in which the lane alert system can alert a user of improper use of a designated passing lane.

FIG. 3 is an illustration 300 depicting a view captured by the camera of the lane alert system.

FIG. 4 is a flowchart of an example process for generating lane alerts and/or initiating a lane change operation.

FIG. 5 is a block diagram of an example computing devices that can be used to implement the methods, systems and processes described in this disclosure.

Like reference numbers and designations in the various drawings indicate like elements.

### DETAILED DESCRIPTION

This application describes systems, methods, and computer program products for implementing a lane alert system. As described in more detail throughout this document, the lane alert system can be configured to detect when a given vehicle (e.g., the vehicle in which the lane alert system is installed) should move from its current lane of travel to a different lane of travel (e.g., in a multi-lane roadway). For example, the lane alert system can determine when the given vehicle is impeding the flow of traffic and/or violating a set of guidelines, rules, or laws of a geographic location (e.g., city, state, country, or other area) where the roadway is located (e.g., where the given vehicle is operating).

In some implementations, the lane alert system determines that the given vehicle is impeding the flow of traffic based on one or more of the speed of the given vehicle, the lane in which the given vehicle is traveling, and/or how many other vehicles are passing the given vehicle. For example, the lane alert system can obtain lane data specifying a lane of the multi-lane roadway is occupied by the given vehicle, as well as vehicle passed data. The vehicle passed data represents instances of the given vehicle being passed by other vehicles. When the lane alert system determines, based on the lane data and the vehicle passed data, that the given vehicle is traveling in a designated passing lane (e.g., according to traffic guidelines, rule, and/or laws of the geographic location) and at least a threshold number of other vehicles have passed the given vehicle, the lane alert system can generate an alert and/or initiate a lane change operation of the given vehicle.

For example, assume that the lane data indicates that the given vehicle is traveling in a designated passing lane (e.g., a left lane) of a multi-lane roadway in Atlanta, GA USA, and that the given vehicle has been passed by more than the threshold number of other vehicles. In this example, the lane alert system can illuminate a light or activate another alert indicator inside the given vehicle to inform the driver that they are impeding traffic and/or to change lanes. As discussed in more detail below, the alerts can be conditioned on other signals (e.g., a current speed of the given vehicle, distance traveled in the current lane, etc.) as well.

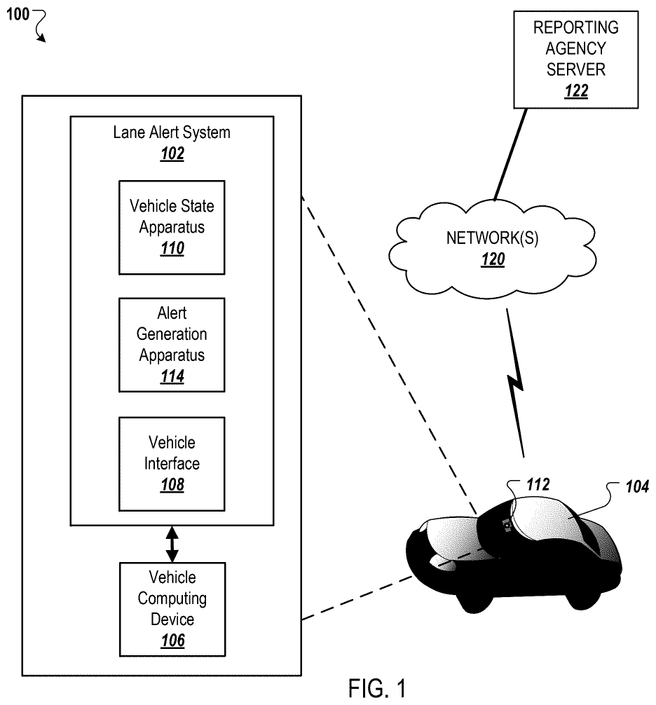

FIG. 1 is an illustration of an environment 100 in which a lane alert system 102 can be implemented. The lane alert system 102 is shown installed in a vehicle 104, and can be communicatively connected to a vehicle computing device 104 (e.g., Engine Control Unit/Computer, Engine Control Module/Computer, and/or another computing device of the vehicle). For example, the lane alert system 102 can include a vehicle interface 108 that is configured to physically and/or communicatively couple the lane alert system 102 to the vehicle computing device 106.

The vehicle interface 108 can be a wired or wireless connection. For example, the vehicle interface can be a short-range wireless connection to the vehicle computing device 106 or another wireless connection to the vehicle computing device 106. In some implementations, the vehicle interface 108 can be configured to connect to the on-board diagnostic (OBD) port of the vehicle 104. The OBD port of the vehicle 104 is an interface through which data generated by the vehicle 104 (e.g., sensors of the vehicle) is accessible. In some implementations, the OBD port of the vehicle complies with the OBD-II specification/standard.

The data generated by the vehicle 104 can include real-time parameters, such as the revolutions per minute (RPM), speed, pedal position, spark advance, airflow rate, coolant temperature, etc. The data generated by the vehicle 104 can also include a freeze frame snapshot of parameters at the time of a specified event occurred. The data generated by the vehicle 104 can include other sensor data, such as data generated when a blind spot detection sensor detects an object (e.g., an auto next to the vehicle), image/video data captured by one or more cameras installed in the vehicle, and/or other sensor data (e.g., Light Detection and Ranging (LIDAR) data, global positioning system (GPS) data, or other data).

The data generated by the vehicle 104 can be in the form of codes that are generated to represent conditions. For example, the vehicle 104 can generate a signal or code when the blind spot detection system detects an object or when a light of the blind spot detection system is illuminated (e.g., indicating an object is detected by the blind spot detection system). Similarly, the data generated by the vehicle 104 can include signals or codes representing the speed of the vehicle and/or a distance traveled (e.g., while a certain condition exists).

The lane alert system 102 can include a vehicle state apparatus 110. The vehicle state apparatus 110 is implemented using one or more data processing apparatus (e.g., processors or computing devices). The vehicle state apparatus 110 is configured to detect/determine a state of the vehicle at any given time and/or over a period of time. In some implementations, the vehicle state apparatus 110 can use the vehicle interface 108 to obtain (e.g., retrieve or access) data generated by the vehicle 104, and use that information to determine a current state of the vehicle 104. For example, the vehicle state apparatus 110 can obtain data generated by sensors of the vehicle, such as lane data, vehicle passed data, speed data, and travel data (e.g., distance data), and use that sensor data to determine whether the vehicle 104 is violating lane guidelines, rules, or laws for the geographic area in which the vehicle 104 is operating.

The sensors that generate the sensor data can include a blind spot detection system, a speedometer, an odometer, a GPS system, a LIDAR system and/or a camera 112. For example, the blind spot detection system can generate signals or codes (e.g., hexadecimal code AE7 or another code) each time an object is detected by the blind spot detection system. In the context of the lane alert system 102, these signals/codes generated by the blind spot detection system can be deemed vehicle passed data, or can be used to generate vehicle passed data. As used herein, vehicle passed data refers to data indicating that another car has passed the car in which the lane alert system 102 is operating. In some implementations, each time the blind spot detection system detects an object, the vehicle state apparatus 110 can increment a counter, and the count of the counter can be considered the vehicle passed data representing how many other vehicles have passed the vehicle 104 in which the lane alert system 102 is operating, which is referred to as a given vehicle 104.

In some implementations, the vehicle state apparatus 110 can be configured to only increment the counter representing a number of instances of the given vehicle being passed when other sensor data further indicates that the object detected by the blind spot detection system moved from a rear of the vehicle 104 to a front of the vehicle 104. For example, the vehicle state apparatus 110 can use the vehicle interface 108 to obtain (e.g., retrieve or access) image/video data collected by the camera 112. As shown, the camera 112 is a forward-facing camera of a rear-view mirror. However, the camera 112 could be mounted at another location of the vehicle 104 and/or multiple cameras could be used together to obtain different views of surrounding vehicles. In some implementations, the camera can be paired with a LIDAR device to obtain more information about vehicles surrounding the given vehicle. For example, the LIDAR device can provide information, such as a distance between the given vehicle 104 and other vehicles (not shown).

The vehicle state apparatus 110 can use the data collected by the camera 112 and/or the data collected by the LIDAR device to determine the location of other vehicles relative to the given vehicle over time. For example, the vehicle state apparatus 110 can determine the location of another vehicle at the detection time when the blind spot detection system detected an object, and then determine whether the other vehicle moved toward the back of the given vehicle 104 or toward the front of the given vehicle 104 over a specified period of time following the detection time.

When the vehicle state apparatus 110 determines that the other vehicle moved toward the front of the given vehicle 104 during the specified period of time following the detection time, the vehicle state apparatus 110 can conclude that the given vehicle 104 was passed, and increment the counter representing the number of times the given vehicle 104 was passed. Meanwhile, when the vehicle state apparatus 110 determines that the other vehicle moved toward the back of the given vehicle 104 during the specified period of time following the detection time, the vehicle state apparatus 110 can conclude that the given vehicle 104 was not passed, and not increment the counter representing the number of times the given vehicle 104 was passed. In this way, the vehicle state apparatus 110 can keep track of the number of times (e.g., instances) in which the given vehicle 104 was passed by other vehicles.

In some implementations, the LIDAR data can also be used to condition incrementing the counter. For example, the vehicle state apparatus 110 can be configured to only increment the counter when the LIDAR data indicates that the other vehicle moved at least a specified distance (e.g., a distance stored in memory of the lane alert system 102) in front of the given vehicle during the specified time frame (e.g., an amount of time stored in memory of the lane alert system 102). Conditioning the incrementation of the counter in this way can reduce the number of times that the counter is incremented when the other vehicle moved toward the front of the given vehicle 104 for a brief period of time, but then was subsequently passed by the given vehicle 104 before the other vehicle reached the specified distance.

The vehicle state apparatus 110 can be configured to also obtain (e.g., retrieve or access) lane data indicative of the lane of a multi-lane roadway in which the given vehicle 104 is traveling. In some implementations, the vehicle state apparatus 110 can obtain data from the camera 112 that is used by the vehicle state apparatus 110 to determine the lane in which the given vehicle 104 is traveling. For example, using object detection techniques, the vehicle state apparatus 110 can identify lane lines in images/video captured by the camera 112. Once the lane lines are identified in the images/video, the vehicle state apparatus 110 can determine whether the given vehicle is traveling in a passing lane (e.g., a left lane of a roadway in the USA, a right lane in some other countries) according to guidelines, rules, and/or laws of the geographic location where the given vehicle 104 is operating.

In some implementations, the passing lane can be the lane of traffic that governs the flow/speed of traffic. For example, in some geographic areas, the leftmost lane of traffic may be the lane of traffic that governs the flow of traffic by being the lane in which faster traveling vehicles are required to pass slower moving vehicles. In this way, the leftmost lane governs the flow of traffic because if a particular vehicle is traveling in the leftmost lane, it should be traveling faster than other vehicles occupying lanes to the right of the leftmost lane. Similarly, in roadways of three or more lanes, vehicles in a lane that is further left than another lane should be traveling faster than the other vehicles traveling in the lanes that are further to the right. This also means that vehicles traveling in lanes to the right of any other lane should not be passing vehicles traveling in lanes to the left, such that the vehicles in the lanes that are further to the left govern the flow of traffic. In this way, the lanes to the left govern the flow of traffic by requiring faster traveling vehicles to pass slower vehicles on the left, and preventing vehicles in lanes to the right of any given lane from traveling faster than the vehicles in the lanes to the left. The same concept applies (in reverse) in jurisdictions where the rightmost lane of traffic governs the flow of traffic by being the lane in which faster traveling vehicles are required to pass slower traveling vehicles. In these situations, the lanes to the right of other lanes are the lanes that govern the flow of traffic.

In some implementations, the vehicle state apparatus 110 can obtain lane data from a lane assist system of the given vehicle 110. The lane data obtained from the lane assist system can specify, or be used to determine, the current lane of travel of the given vehicle. The vehicle state apparatus 110 can then determine whether the current lane of travel of the given vehicle 104 is a designated passing lane for the geographic area in which the given vehicle 104 is currently operating.

For example, a memory of the lane alert system 102 can store a list of geographic areas and the designated passing lanes for each of those geographic areas. When the by the vehicle state apparatus 110 determine the current lane of travel, the vehicle state apparatus 110 can compare the current lane of travel to the stored designated passing lanes for the geographic area. When a match between the current lane of travel and the stored designated passing lanes for the geographic area is detected, the vehicle state apparatus 110 can determine/conclude that the given vehicle 104 is traveling in a designated passing lane. When a match between the current lane of travel and the stored designated passing lanes for the geographic area is not detected, the vehicle state apparatus 110 can determine/conclude that the given vehicle 104 is not traveling in a designated passing lane.

In some implementations, the vehicle state apparatus 110 can be configured to only obtain the vehicle passed data when the vehicle state apparatus 110 determines that the given vehicle 104 is traveling in a designated passing lane. In this way, the amount of data transferred to, and processed by, the lane alert system 102 can be reduced relative to continually obtaining and processing data irrespective of the current lane of travel.

In some implementations, the vehicle state apparatus 110 can be configured to only increment the counter tracking the number of times the given vehicle 104 has been passed when the current lane of travel is determined to be a designated passing lane. For example, in situations where the vehicle state apparatus 110 determines that the other vehicle passed the given vehicle, as discussed above, the vehicle state apparatus 110 can increment the counter when the current lane of travel is determined to be a designated passing lane, and can refrain from incrementing the counter when the current lane of travel is not a designated passing lane. Conditioning the incrementation of the counter in this way can reduce the number of times that the counter is incremented when the given vehicle 104 is not in a designated passing lane.

The lane alert system 102 includes an alert generation apparatus 114. The alert generation apparatus 114 is implemented using one or more processors or computing devices, and is configured to generate an alert based, at least, on the lane data and the vehicle passed data. In some implementations, the alert generation apparatus 114 generates an alert when the given vehicle 104 has been passed at least a specified number of times while traveling in a designated passing lane. In some implementations, the alert generation apparatus 114 monitors the counter that is incremented as discussed above. For example, when the given vehicle 104 is traveling in a designated passing lane and the counter reaches a specified value (e.g., 2, 3, 5, 10, or another number) indicating that the given vehicle 104 has been passed the specified number of times (e.g., a value stored in a memory of the lane alert system 102), the alert generation apparatus 114 can generate the alert.

Generation of the alert can include the creation of a signal or code that causes a light or another indicator inside the given vehicle 104 to be activated. For example, a lane change light, or another visual indicator, can be illuminated informing the driver of the given vehicle 104 that they are being repeatedly passed by other vehicles while traveling in a designated passing lane. The alert can also include the generation of an audible alert informing the user that they are being repeatedly passed by other vehicles while traveling in a designated passing lane.

The generation of the alert can initiate a lane change operation. The lane change operation can cause the presentation of instructions, such as change lane instructions, to be presented to the driver. For example, the instructions can inform the driver that they should move to a different lane that is not a designated passing lane. The lane change operation can also include illumination of an exterior notification. For example, a mirror of the given vehicle 104 can include an exterior notification device, such as a light (e.g., in the shape of an arrow), which can be illuminated to inform drivers of other vehicles that the given vehicle 104 is going to be changing lanes. The exterior notification device can be in another component of the given vehicle 104. For example, the exterior notification device can be embedded or placed on a portion of the rear window, on a bumper, on a roof, and/or on another portion of the given vehicle 104.

The generation of the alert can be conditioned on a distance traveled by the given vehicle 104. Conditioning the generation of the alert on a distance traveled by the given vehicle 104 provides the driver of the given vehicle 104 time to change lanes on their own, or increase their speed on their own before an alert is generated. In some implementations, the generation of the alert is conditioned on the given vehicle 104 traveling at least a mile, 1.5 miles, 2 miles, or some other pre-specified/given distance (e.g., stored in a memory of the lane alert system 102) before the alert can be generated based on the lane data and the vehicle passed data.

For purposes of determining whether the distance traveled by the given vehicle 104 is sufficient to meet the condition for generating the alert, the distance can be determined from a point in time (or location) at which the given vehicle 104 entered a designated passing lane, a point in time (or location) at which the given vehicle 104 was first passed by another vehicle while in the designated passing lane, a point in time (or location) at which the given vehicle 104 was traveling below the posted speed limit of the roadway while in the designated passing lane, or another point in time. For example, assume that the given vehicle 104 entered the designated passing lane at 11 am, at mile marker 2 of the roadway, which is located at a specific set of geographic coordinates (e.g., GPS coordinates). In this example, when other conditions required for generating an alert (e.g., the given vehicle is traveling in a designated passing lane, has been passed by the specified number of other vehicles, and/or is traveling below the posted speed limit for the roadway), the lane alert system 102 can determine whether the given vehicle 104 has been traveling in the designated passing lane long enough (e.g., for at least the specified distance) to generate the alert. More specifically, the lane alert system 102 can determine how far the given vehicle 104 has traveled in the designated passing lane, and compare the distance traveled in the designated passing lane to the specified distance. When the distance traveled in the designated passing lane meets or exceeds the specified distance, the lane alert system 102 (e.g., by way of the alert generation apparatus 114) can enable the generation of the alert. Meanwhile, if/while the distance traveled in the designated passing lane fails to (does not) meet the specified distance, the lane alert system 102 can prevent the alert generation apparatus 114 from generating the alert.

The distance traveled by the given vehicle 104 in the designated passing lane can be determined using various different types of travel data. For example, the lane alert system 102 can use GPS data, odometer data, and/or a combination of time data and speed data to determine the distance the given vehicle 104 has traveled in the designated passing lane. For example, the lane alert system 102 can obtain GPS data specifying a geographic location at which the given vehicle 104 entered the designated passing lane and a current geographic location of the given vehicle 104. In this example, the lane alert system 102 can determine the distance between the two geographic locations, and use this distance as the distance traveled by the given vehicle 104.

With respect to odometer data, the lane alert system can determine/record a starting odometer reading at the time the given vehicle 104 entered the designated passing lane and the current odometer reading (e.g., using OBD-II codes or querying the given vehicle's computer). The lane alert system 102 can then determine a difference between the current odometer reading and the starting odometer reading, and this difference can be used as the distance traveled in the designated passing lane by the given vehicle 104.

With respect to the time data and speed data, the lane alert system 102 can determine the distance traveled in the designated passing lane as a product of (i) the amount of time since the given vehicle 104 entered the designated passing land and (ii) the speed of the given vehicle 104 over the elapsed time. For example, assume that the lane alert system 102 determines that the given vehicle 104 entered the designated passing lane at 11:00 am, and the current time is 11:02 am. In this example the lane alert system 102 can compute a difference between the current time and the time at which the given vehicle 104 entered the designated passing lane. In the present example, this difference, which is referred to as the elapsed time since entering the designated passing lane, would be computed to be 120 seconds (or 2 minutes, or 1/30^{th} of an hour). The lane alert system 102 can multiply this elapsed time by the average speed of the given vehicle 104 over the elapsed time (e.g., from 11:00 am to 11:02 am) to obtain the distance traveled in the designated passing lane by the given vehicle 104.

In some implementations, the distance the given vehicle 104 has traveled in the designated passing lane can be reset in various situations. For example, the distance the given vehicle 104 has traveled in the designated passing lane can be reset when the given vehicle exits the designated passing lane and enters a non-passing lane (e.g., the rightmost lane in the US, but the leftmost lane in some countries). The distance the given vehicle 104 has traveled in the designated passing lane can also be reset when the given vehicle 104 is traveling within a specified distance of the rear of another vehicle that is also traveling in the designated passing lane. In these situations, the speed of the given vehicle 104 is likely being impeded by the other vehicle that is traveling in front of the given vehicle 104, such that the given vehicle 104 may not be able to travel the speed they would like to travel. Other conditions can also be defined for resetting the distance traveled in the designated passing lane.

The lane alert system 102 can be configured to store a log of alerts generated by the alert generation apparatus 114. For example, the lane alert system can include a memory device (not shown) that can store a log of alerts. For example, each time an alert is generated and/or each time a device (e.g., lamp, audio device, etc.) is activated based on the generation of an alert, the lane alert system 102 can store data representing the alert and a time of the alert. This stored alert log can be used, for example, to determine a frequency (e.g., number of alerts over time) and/or an aggregate number of alerts generated by the given vehicle 104. Using this information, the lane alert system 102, or another data processing apparatus, can escalate alerts or other notifications to the driver of the given vehicle 104. For example, if the frequency or aggregate number of alerts meets or exceeds a threshold alert level, the lane alert system 102 (or another data processing apparatus) can change the type of notification provided to the driver of the given vehicle 104. For example, the driver may be emailed or otherwise contacted informing them that they have exceeded the threshold alert level, and optionally, offer the driver education materials about the use of the designated passing lane.

In some implementations, the lane alert system 102 can transmit information regarding alerts generated for the given vehicle 104 to remote systems over a network 120.

The network 120 can be a local area network (LAN), a wide area network (WAN), the Internet, or a combination thereof. The network 120 connects the given vehicle 104 and/or the lane alert system 102 to a reporting agency server 122 (e.g., by way of a wireless connection 124 between the given vehicle 104 and the network 120). For brevity, the discussion that follows refers to connecting the given vehicle 104 to the reporting agency server 122, but the discussion that follows is equally applicable to connecting the lane alert system 102 to the reporting agency server 122.

The network 102 may include various networking technologies that connect the given vehicle 104 to the reporting agency server 122, including (among others) cellular data networks, Wi-Fi or WiMAX networks, satellite communication networks, metropolitan-area networks (MANs), wide-area networks (WANs), the Internet (TCP/IP), etc. The backhaul system of the network, the connection between the user device 110 and the network server 150, may comprise ethernet, cellular (3G, 4G, 4G LTE, etc.), Wi-Fi or other wireless local area network (LAN) (IEEE 802.11), wired LAN (IEEE 802.3), satellite phone (IRIDIUM), wireless personal area network (WPAN) (IEEE 802.15), or any other telecommunications link, wired or wireless.

The reporting agency server 122 is a computing device configured to receive alert data from the lane alert system 102. In some implementations, the reporting agency server 122 is a server of a service configured to collect the alert data (e.g., transmitted to the reporting agency server 122 by the lane alert system 102), and communicate with the driver of the given vehicle 104 based on the nature of the alert data. For example, assume that the alert data received from the given vehicle 104 indicates that the lane alert system 102 has generated at least a threshold number of alerts, or generated alerts with at least a threshold frequency. In this example, the reporting agency sever 122 can transmit, or otherwise provide, information about designated passing lane use to the driver of the given vehicle 104. In some implementations, the reporting agency server 122 can be a server of an enforcement agency. In these implementations, the reporting agency server 122 can issue warnings or citations (e.g., fines) based on the received alert data indicating improper use of the designated passing lane.

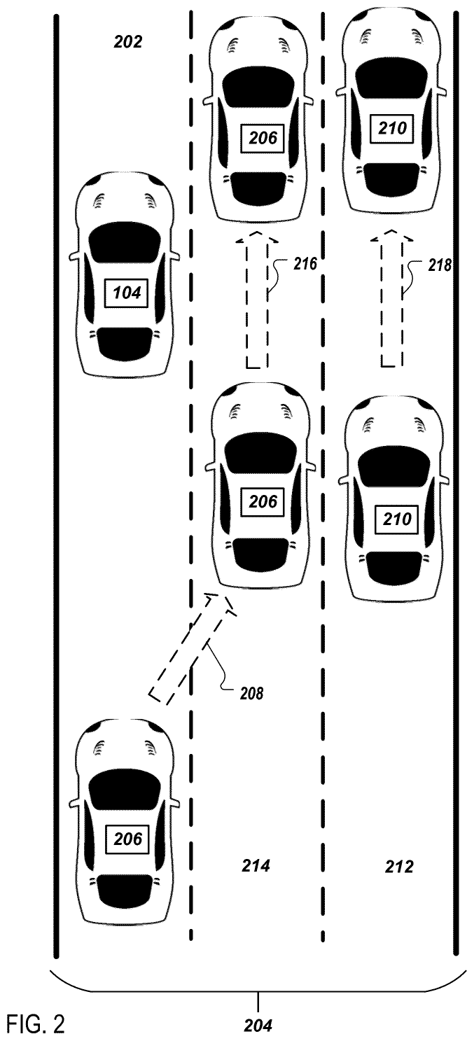

FIG. 2 is an illustration 200 of an example roadway in which the lane alert system 102 can alert a user of improper use of a designated passing lane. In particular, FIG. 2 shows the given vehicle 104 traveling in a leftmost lane 202 of a multilane roadway 204. In this example, assume that the leftmost lane 202 is a designated passing lane, and that the given vehicle 104 is driving below the posted speed limit for the multilane roadway 204. As such, in this example, the given vehicle 104 is deemed a slower driver in the designated passing lane, which can cause traffic delays, traffic congestion, and/or dangerous conditions as other vehicles pass the given vehicle 104.

For example, assume that the other vehicle 206 is traveling in the leftmost lane 202 at the speed limit for the multilane roadway 204. As the other vehicle 206 approaches, the given vehicle 104, the other vehicle 206 will need to change lanes, as shown by the arrow 208 into a lane adjacent (e.g., lane 214) to the designated passing lane (e.g., the leftmost lane 202). Further assume that yet another vehicle 210 is traveling in the rightmost lane 212. In this scenario, the vehicles 206 and 210 are being put at risk of a wreck when the slow travel of the given vehicle 104 causes the vehicle 206 to change lanes to the lane 214. Specifically, the vehicle 210 and the vehicle 206 may end up trying to move into the lane 212 at the same time if the drivers of these vehicles 206 and 210 do not see each other moving into the lane 214. This scenario illustrates one of the use cases for the lane alert system discussed herein.

When the given vehicle 104 is outfitted with the lane alert system discussed with reference to FIG. 1, the lane alert system will detect the vehicle 206 passing the given vehicle 104 (as illustrated by the arrow 216, and can generate an alert to the driver of the given vehicle 104, as discussed above. In this way, the driver of the given vehicle 104 will be informed of their improper use of the designated passing lane (e.g., lane 202), and guided to move out of the designated passing lane 202.

The previous example explains the detection of the given vehicle 104 being passed in the lane (e.g., lane 214) that is adjacent to the designated passing lane (e.g., lane 202. In some implementations, the lane alert system can be configured to detect vehicles in other lanes, such as those at least two lanes away from the designated passing lane. With reference to FIG. 2, the lane alert system installed in the given vehicle 104 can be configured to detect the vehicle 210 passing the given vehicle 104 in the lane 212 while the given vehicle is traveling in the lane 202 (as indicated by the arrow 218). In this scenario, the detection of the vehicle 210 and the generation of the alert can be performed as discussed above with reference to FIG. 1.

In some implementations, the lane alert system can be configured to detect improper use of a center lane, and generate an alert when the vehicle in which the lane alert system is installed is passed by another vehicle that is traveling in a lane that is not designated as a passing lane. For example, with reference to FIG. 2, assume that the vehicle 206 is traveling in the lane 214, but is passed by the vehicle 210, which is traveling in the lane 212. Assuming for purposes of this example, that the vehicles are traveling in the United States, the lane 202 is a designated passing lane, but the lane 214 can also be considered a designated passing lane. For example, when there are three or more lanes in a roadway, each lane that is not the furthest from the designated passing lane (e.g., lane 202 in this example) can be considered a designated passing lane, while the lane that is furthest from the designated passing lane (e.g., the leftmost lane in locations where the rightmost lane is the designated passing lane) is not a designated passing lane. Of course, in locations where the rightmost lane (e.g., lane 212) is designated as the passing lane, the leftmost lane is not a designated passing lane, and each lane between the designated passing lane and the lane furthest from the designated passing lane can also be considered designated passing lanes.

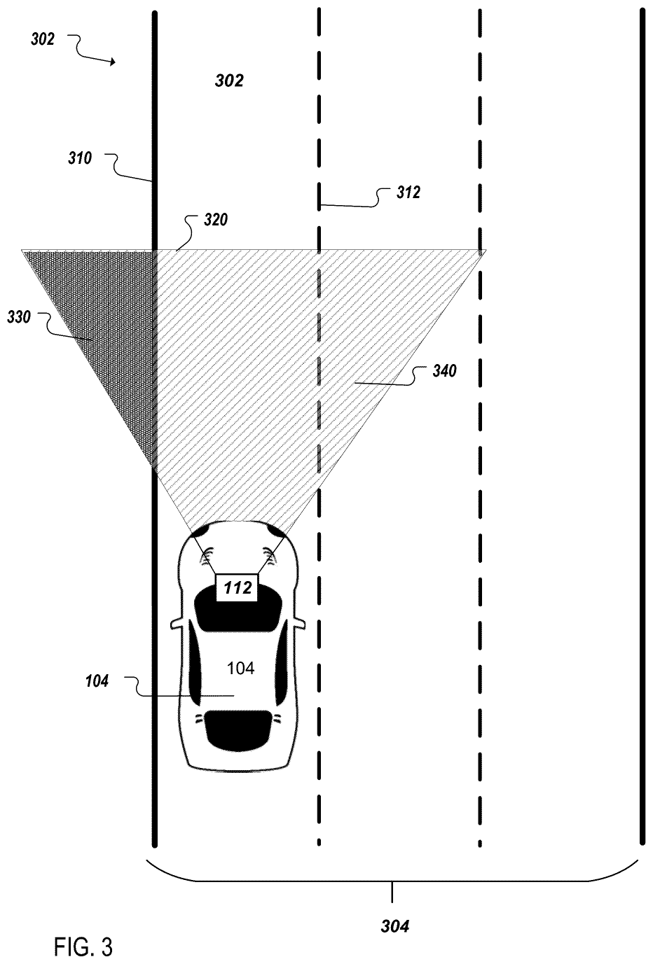

FIG. 3 is an illustration 300 depicting a view captured by the camera 112 of the lane alert system. In this example, the camera 112 is shown as capturing image data and detecting whether the given vehicle 104 is traveling in a designated passing lane (e.g., the leftmost lane 302 of roadway 304. In this example, the leftmost lane 302 is marked by a solid line 310 on the left side, and a dashed line 312 on the right side, relative to the given vehicle 104. As the lane alert system acquires the image data, a determination can continuously (or periodically) be made as to whether the given vehicle 104 is traveling in a designated passing lane, such as the leftmost lane 302 of the roadway 304, as discussed above. In some implementations, other types of sensors may be used to detect that the given vehicle 104 is traveling in a designated passing lane.

As illustrated, the shaded area 320 denotes the portion of the roadway 304 that is captured by the camera 112 of the lane alert system. This portion of the roadway 304 can be captured in the form of image data. The image data can include image data representing a right view portion 340 that is captured on the right side of the solid line 310. The image data can also include image data representing a left view portion 330 that is captured on the left-hand side of the solid line 310. In some situations, the image data for the left view portion 330 can be used to identify one or more roadway features, such as signs or other features that are located to the left of the solid line 310. In some situations, the image data for the view left portion 330 can be ignored and/or discarded. For example, when the lane alert system is determining whether a second vehicle is ahead of the given vehicle 104, the image data for the left view portion 330 can be ignored.

As the lane alert system acquires the image data from the field of view of the camera 112, a repository of image data can be stored. For example, while the given vehicle 104 is in operation, a collection of image data can be stored. The image data can be used in real time for the operation of the lane alert system. In some implementations, the image data can be stored and accessed at a later time (e.g., by a reporting agency server).

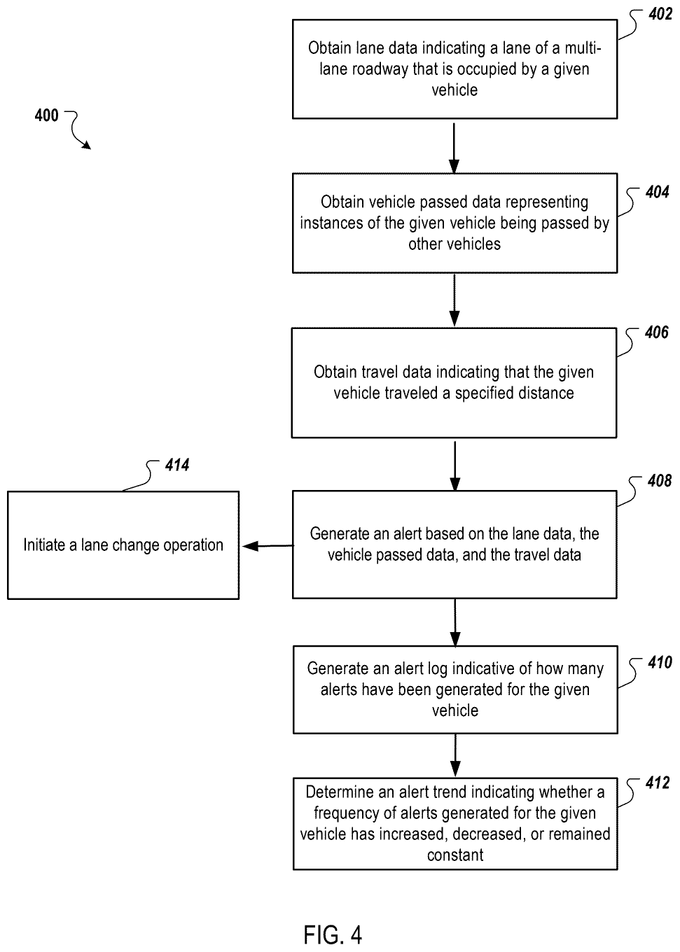

FIG. 4 is a flowchart of an example process 400 for generating lane alerts and/or initiating a lane change operation. The process 400 can be implemented, for example, by the lane alert system 102 of FIG. 1 or another data processing apparatus (e.g., including one or more processors). Operations of the process 400 can also be implemented as instructions stored on non-transitory computer readable media, and execution of the instructions by one or more data processing apparatus (or computing devices) can cause the one or more data processing apparatus to perform the operations of the process 400.

Lane data indicating a lane of a multi-lane roadway that is occupied by a given vehicle is obtained (402). In some implementations, the lane data is obtained from/by a first sensor of the given vehicle. For example, as discussed above, the lane data can be obtained from a camera and/or another device, such as a LIDAR sensor that is installed on the given vehicle. The lane data obtained can directly specify the lane of travel for the given vehicle and/or include data from which the lane of travel can be determined. For example, the lane data obtained can expressly specify that the given vehicle is traveling in a leftmost lane, a center lane, or a rightmost lane. In another example, the lane data obtained can include image data or other information from which the lane of travel can be determined. In either case, the lane of travel is considered to be indicated by the lane data.

As previously discussed, the camera (or another sensor) can acquire image data that depicts a view in a forward direction relative to the given vehicle. In some implementations, that image data can be obtained as part of obtaining the lane data.

As part of obtaining the lane data, a determination of the lane of travel can be performed using the image data. For example, the output of the determination can reveal that the given vehicle is occupying a designated passing lane for the current location or a lane that has not been designated as a passing lane, which can be referred to as a non-passing lane for brevity. To illustrate, assume that the given vehicle is traveling in the leftmost lane of a multi-lane roadway. In this example, the determination can be made that the given vehicle is occupying the leftmost lane, which is a designated passing lane in the United States, based on the image data. Of course, in other countries where the designated passing lane is the rightmost lane, the determination of whether the given vehicle is occupying a designated passing lane could be based on whether the given vehicle is occupying a rightmost lane, or a lane that is at least one lane to the right of the leftmost lane, which would be the non-passing lane in those countries where the designated passing lane is the rightmost lane.

In some implementations, object recognition can be performed on the image data to determine that the user's vehicle is traveling in a designated passing lane of the roadway. For example, the object recognition can be used to determine that a particular roadway feature indicative of travel in the designated passing lane is positively identified in the image data. In some situations, the particular roadway feature that leads to the determination that the given vehicle is traveling in the designated passing lane can include, but is not limited to, a solid white line, double yellow lines, a guard rail, a high occupancy vehicle (HOV) lane with double white lines, or the like being in a specified area of the image data. For instance, when the object recognition identifies one of these particular roadway features at specific locations in the image data, the conclusion can be made that the user's vehicle is traveling in the designated passing lane. More specifically, the output of the determination can indicate that the given vehicle is traveling in the leftmost lane when any of the roadway features listed above are determined to be located on a left side of the captured image, and/or that there is at least one lane of travel to the right of the lane occupied by the given vehicle when the given vehicle is traveling in a location where the leftmost lane is considered a designated passing lane. Of course, a similar determination can be made when the roadway features are determined to be on a right side of the captured image and/or there is at least one lane of travel to the left of the lane occupied by the given vehicle when the given vehicle is traveling in a location where the rightmost lane is considered a designated passing lane.

Vehicle passed data is obtained (404). In some implementations, the vehicle passed data represents instances of the given vehicle being passed by other vehicles. The vehicle passed data can be obtained, for example, from a second sensor installed in the given vehicle. The second sensor can be a sensor used to trigger a blind spot alert and/or generate blind spot data, as previously discussed. For example, when an object (e.g., another vehicle) is detected by a sensor of the blind spot detection system, the blind spot data indicating the detection of the object can be generated and obtained. In this example, each instance of an object being detected by the blind spot detection system can lead to an instance of blind spot data being generated. This blind spot data alone can be considered vehicle passed data, or the vehicle passed data can be generated based on a combination of the blind spot data and additional data, such as camera data indicating that the detected vehicle moved from a rear of the given vehicle to the front of the given vehicle, as previously discussed. In either case, each instance of vehicle passed data represents an instance of the given vehicle being passed by another vehicle, and the number of instances of vehicle passed data obtained can equal to, or be used to determine, how many (e.g., a number of) other vehicles that passed the given vehicle.

In some implementations, the number of other vehicles that passed the given vehicle while the given vehicle traveled a specified distance is determined. As discussed elsewhere, the generation of an alert (408) can be triggered when the number of other vehicles that passed the given vehicle while the given vehicle traveled the specified distance meets a threshold number. In some implementations, the determination of the number of vehicles that passed the given vehicle while the given vehicle traveled the specified distance is based on blind spot data and additional data. The blind spot data indicating that a blind spot monitoring system detected the other vehicles while the given vehicle traveled the specified distance can be obtained, as previously discussed. The additional data can indicate that the other vehicles moved from a back of the given vehicle to a front of the vehicle while the given vehicle traveled the specified distance can also be obtained, as previously discussed. Using this combination of data can result in the generation of vehicle passed data, which can be used to determine the number of other vehicles that passed the given vehicle over the specified distance.

Travel data is obtained (406). In some implementations, the travel data indicates that the given vehicle traveled a specified distance. As previously discussed, the travel data can be obtained in a variety of ways. For example, the travel data can be, or be determined based on, GPS data, odometer data, and/or a combination of time data and speed data to determine the distance the given vehicle has traveled, e.g., in a designated passing lane. For example, the GPS data (from a GPS device) specifying a geographic location at which the given vehicle entered the designated passing lane as well as a current geographic location of the given vehicle can be obtained. In this example, the distance between the two geographic locations can be determined and used as the distance traveled by the given vehicle.

With respect to odometer data, the travel data can be obtained by determining/recording a starting odometer reading at the time the given vehicle entered the designated passing lane and the current odometer reading (e.g., using OBD-II codes or querying the given vehicle's computer). A difference between the current odometer reading and the starting odometer reading can then be determined, and this difference can be used as the distance traveled in the designated passing lane by the given vehicle.

With respect to the time data and speed data, the distance traveled in the designated passing lane can be determined as a product of (i) the amount of time since the given vehicle entered the designated passing lane and (ii) the speed of the given vehicle over the elapsed time. For example, assume it is determined that the given vehicle entered the designated passing lane at 11:00 am, and the current time is 11:02 am. In this example, a difference (e.g., subtraction operation) between the current time and the time at which the given vehicle entered the designated passing lane can be computed. In the present example, this difference, which is referred to as the elapsed time since entering the designated passing lane, would be computed to be 120 seconds (or 2 minutes, or 1/30th of an hour). This elapsed time can then be multiplied by the average speed of the given vehicle over the elapsed time (e.g., from 11:00 am to 11:02 am) to obtain the distance traveled in the designated passing lane by the given vehicle.

In some implementations, route data can be included in the obtained travel data and/or obtained separate from the travel data. Route data can be obtained, for example, from a navigation system of the given vehicle. The route data can specify one or more of a starting location of the route, an end location of the route, and a path of travel (e.g., roadways and turns) the given vehicle will travel along the route. The route data can also specify one or more stops (e.g., geographic locations at which the given vehicle is scheduled to stop) along the route. The stops can include, for example, gas stations along the route, charging stations along the route, restaurants along the route, or other locations at specified geographic coordinates along the route.

In the context of electric vehicles, the route data will specify stops at the geographic locations of one or more charging station along the route. The specific stops included in the route data can be based, for example, on the total distance to be traveled along the route, battery characteristics (e.g., starting charge, remaining charge, etc.) of the electric vehicle, locations of charging stations along the route, charging capabilities of the charging stations along the route, and/or other information that can be considered when determining optimal stops for recharging an electric vehicle.

When the specific stops are specified in the route data, the information related to these specific stops (e.g., geographic locations) can be considered when implementing the alerts discussed herein. For example, in some implementations, the lane alert system in a given vehicle can disable alerts and/or monitoring when the given vehicle is traveling according to the route data, and/or the given vehicle is within a pre-specified distance (e.g., 1 mile, 1.5 miles, 2 miles, or another pre-specified distance) of a stop, such as an electric charging station or a roadway exit/turn that will be navigated to exit (or turn off of) the multi-lane roadway currently being navigated by the given vehicle. In the context of an autonomous vehicle, the lane alert system can disable alerts and/or monitoring when the autonomous vehicle is in self-driving mode (e.g., where human intervention is not required to navigate the route). However, in some implementations, the lane alert system can be integrated into, or in communication with, the autonomous vehicle to inform the path selected/navigated by the autonomous vehicle in self-driving mode, such that alerts may not be generated, but the travel path of the autonomous vehicle is selected, at least in part, by data output by the lane alert system. In other words, the data generated by the lane alert system can be input to the autonomous vehicle, which can adjust the path traveled by the autonomous vehicle based on the data generated by the lane alert system. Similarly, a navigation system of any given vehicle can be configured to communicate with the lane alert system to similarly adjust the path traveled by the given vehicle, for example, by updating the route based on the data from the lane alert system.

In some implementations, the travel data and/or distance the given vehicle has traveled in the designated passing lane can be reset in various situations. For example, a reset can be triggered when the given vehicle is an electric vehicle that has moved into the designated passing lane according to a route that is leading the given vehicle to a charging station, or another designated stop (e.g., along a planned route). A reset can also be triggered when the given vehicle is an autonomous vehicle placed into self-driving mode, such that the route and/or lane are taking into account various factors that contribute to the lane being occupied by the autonomous vehicle.

In some situations, a reset can be triggered when the given vehicle exits the designated passing lane and enters a non-passing lane (e.g., the rightmost lane in the US, but the leftmost lane in some countries). A reset can also be triggered when the given vehicle is traveling within a specified distance of the rear of another vehicle that is also traveling in the designated passing lane. In these situations, the speed of the given vehicle is likely being impeded by the other vehicle that is traveling in front of the given vehicle, such that the given vehicle may not be able to travel the speed they would like to travel, and may not be voluntarily maintaining their current speed. Other conditions can also be defined for resetting the distance traveled in the designated passing lane.

In some implementations, the given vehicle can determine the speed of other vehicles on the roadway, and use the determined speed of other vehicles as part of the travel data. The speed of other vehicles can be determined by the given vehicle in various ways. For example, the given vehicle can include sensors, such as radar sensors LIDAR sensors or other sensors that can facilitate determination of the speed of other vehicles. These or other sensors can be used to directly detect the speeds of other vehicles.

In some implementations, the given vehicle can determine the speeds (e.g., relative or actual speeds) of other vehicles based on a change in distance over time between the given vehicle and other vehicles. More specifically, determining the rate of change in distance between the given vehicle and a different vehicle, a determination can be made as to one or more of the difference between (i) the speed of the given vehicle and (ii) the speed of the different vehicle and/or the actual speed of the different vehicle.

The speed difference between the given vehicle and the different vehicle can be determined based on the distance between the two vehicles at a first time, the distance between the two vehicles at a second time, and the amount of time between the first time and the second time that define a measurement duration or time period. The distance between the given vehicle and the different vehicle can be determined for example, using data from a radar sensor, LIDAR sensor, a camera, a GPS sensor, and/or another sensor. For example, data collected from a LIDAR sensor, a camera, or a radar sensor can provide distance data indicating a distance between the given vehicle and the different vehicle. With respect to GPS data, the geographic locations of the given vehicle and the different vehicle can be determined from the GPS data, and the distance between the geographic locations of the vehicles can be deemed the distance between the two vehicles.

The distances between the given vehicle and the different vehicle can be determined at two different points in time. For example, assume that the first distance between the two vehicles (e.g., 0.3 miles) is determined at an initial time 11:00 am (e.g., time t=0), and the second distance between the two vehicles (e.g., 0.1 miles) is determined at a later time 11:03 am (e.g., t=0.05 hours). In this example, the distance between the two vehicles changed by 0.2 miles in 0.05 hours, such that the difference in speed between the two vehicles is 0.2 miles/0.05 hours, which is a 4 miles/hour difference.

Using the difference in speed between the two vehicles and the current speed of the given vehicle, the system in the given vehicle can determine the absolute speed of the different vehicle. For example, assume that the given vehicle is traveling at 50 miles per hour and that the different vehicle is approaching/nearing the given vehicle from behind. In this example, the system can determine that the different vehicle is traveling at 54 miles per hour by adding the speed difference of 4 miles per hour to the 50 miles per hour speed of the given vehicle. In another example, assume that the given vehicle is approaching/nearing the different vehicle from behind meaning that the given vehicle is traveling faster than the different vehicle. In this example, the given vehicle can determine that the absolute speed of the different vehicle is 46 miles per hour (assuming the same change in distance/time as above) by subtracting the 4 miles per hour speed difference from the 50 miles per hour speed of the given vehicle. This information can be used to determine which vehicle is responsible for a traffic slow down, e.g., depending on which of the two vehicles is traveling slower.

An alert is generated based on the lane data, the vehicle passed data, and/or the travel data (408). In some implementations, the alert is generated when the given vehicle has been passed at least a specified number of times (e.g., by at least the specified number of vehicles) while traveling in a designated passing lane. In some implementations, the number of vehicles that passed the given vehicle is determined/tracked using a counter that is incremented, as discussed above. For example, when the given vehicle is traveling in a designated passing lane and the counter reaches a specified value (e.g., 2, 3, 5, 10, or another number) indicating that the given vehicle has been passed the specified number of times (e.g., a value stored in a memory of the lane alert system), the alert can be generated. As discussed elsewhere, the number of (e.g., how many) vehicles passed the given vehicle can be determined over a period of time while the given vehicle traveled at least a specified distance and/or in the designated passing lane.

Generation of the alert can include the creation of a signal or code that causes a light or another indicator inside the given vehicle to be activated. For example, a lane change light, or another visual indicator, can be illuminated informing the driver of the given vehicle that they are being repeatedly passed by other vehicles while traveling in a designated passing lane. The alert can also include the generation of an audible alert informing the user that they are being repeatedly passed by other vehicles while traveling in a designated passing lane.

The generation of the alert can be conditioned on a distance traveled by the given vehicle. Conditioning the generation of the alert on a distance traveled by the given vehicle provides the driver of the given vehicle time to change lanes on their own, or increase their speed on their own before an alert is generated. In some implementations, the generation of the alert is conditioned on the given vehicle traveling at least a mile, 1.5 miles, 2 miles, or some other pre-specified/given distance (e.g., stored in a memory of the lane alert system) before the alert can be generated based on the lane data and the vehicle passed data. More specifically, using the lane data, a determination can be made that the given vehicle is traveling in a designated passing lane, and the travel data can be used to determine the distance the given vehicle has traveled while occupying the designated passing lane. Using this data, the alert can be conditioned on (i) the given vehicle traveling in the designated passing lane over the given distance, and (ii) the number of vehicles that passed the given vehicle over the given distance meeting a threshold number.

For purposes of determining whether the distance traveled by the given vehicle is sufficient to meet the condition for generating the alert, the distance can be determined from a point in time (or location) at which the given vehicle entered a designated passing lane, a point in time (or location) at which the given vehicle was first passed by another vehicle while in the designated passing lane, a point in time (or location) at which the given vehicle was traveling below the posted speed limit of the roadway while in the designated passing lane, or another point in time. For example, assume that the given vehicle entered the designated passing lane at 11 am, at mile marker 2 of the roadway, which is located at a specific set of geographic coordinates (e.g., GPS coordinates). In this example, when other conditions required for generating an alert (e.g., the given vehicle is traveling in a designated passing lane, has been passed by the specified number of other vehicles, and/or is traveling below the posted speed limit for the roadway) are met, the determination of whether the given vehicle has been traveling in the designated passing lane long enough (e.g., for at least the specified distance) to generate the alert can be determined. More specifically, the distance the given vehicle has traveled in the designated passing lane can be determined and compared to the specified distance. When the distance traveled in the designated passing lane meets or exceeds the specified distance, generation of the alert can be enabled. Meanwhile, if/while the distance traveled in the designated passing lane fails to (does not) meet the specified distance, the alert generation can be prevented.

In some implementations, the generation of an alert can be conditioned on whether the given vehicle is the cause of a traffic delay (e.g., slow down). For example, using the absolute speed of the given vehicle and/or the difference in speed between the given vehicle and another vehicle can be used to determine whether the alert is generated. Returning to the previous example in which the difference between the speed of the given vehicle and a different vehicle was determined (e.g., using the change in distances over time), the slower of the two vehicles can be deemed the cause of a traffic delay in the passing lane. When the given vehicle determines that the given vehicle is the cause of the traffic delay based on the determination that the given vehicle is traveling slower than, and in front of, the different vehicle, the alert can be generated and presented in the given vehicle as previously discussed. When the given vehicle determines that the different vehicle is the cause of the traffic delay based on the determination that the different vehicle is traveling slower than, and in front of, the given vehicle, the given vehicle can refrain from (or prevent) generating and presenting the alert within the given vehicle. However, the given vehicle could generate and present an alternative alert that can either be transmitted to the different vehicle, a reporting agency, or another system. Similarly, the given vehicle could generate and present a notification instructing the driver of the given vehicle to pass the different vehicle in another travel lane to avoid a multi-car delay in the passing lane.

An alert log is generated (410). In some implementations, the alert log is indicative of how many alerts have been generated for the given vehicle. The alert log can be stored in a memory device. Each time an alert is generated and/or each time a device (e.g., lamp, audio device, etc.) is activated based on the generation of an alert, the alert data representing the alert and a time of the alert can be stored in the alert log. This stored alert log can be used, for example, to determine a frequency (e.g., number of alerts over time) and/or an aggregate number of alerts generated by the given vehicle. Using this information, alerts or other notifications to the driver of the given vehicle can be escalated depending on the frequency or aggregate number of alerts generated. For example, if the frequency or aggregate number of alerts meets or exceeds a threshold alert level, the type of notification provided to the driver of the given vehicle can be changed. For instance, the driver may be emailed or otherwise contacted informing them that they have exceeded the threshold alert level, and optionally, offer the driver education materials about the use of the designated passing lane.

An alert trend is determined based on the alert log (412) In some implementations, the alert trend indicates whether a frequency of alerts generated for the given vehicle has increased, decreased, or remained constant (e.g., within a threshold variance of a given level). In some implementations, the driver of the given vehicle can be notified when their alert trend indicates that the frequency of alerts has increased. For example, the driver of the given vehicle can be provided with information about proper usage of the designated passing lane and/or given a warning about future improper usage of designated passing lanes.

A lane change operation can be initiated based on the alert (414). In some implementations, initiating the lane change operation includes illuminating a lane change indicator on a mirror of the given vehicle. In some implementations, initiating the lane change operation includes autonomously navigating the given vehicle to a different lane of the multi-lane roadway.

In some implementations, the lane change operation can cause the presentation of instructions, such as change lane instructions, to be presented to the driver of the given vehicle. For example, the instructions can inform the driver that they should move to a different lane that is not a designated passing lane or increase their speed. The lane change operation can also include illumination of an exterior notification. For example, a mirror of the given vehicle can include an exterior notification device, such as a light (e.g., in the shape of an arrow), which can be illuminated to inform drivers of other vehicles that the given vehicle is going to be changing lanes by exiting the designated passing lane in the direction of the non-passing lane. The exterior notification device can be in another component of the given vehicle. For example, the exterior notification device can be embedded or placed on a portion of the rear window, on a bumper, on a roof, and/or on another portion of the given vehicle.

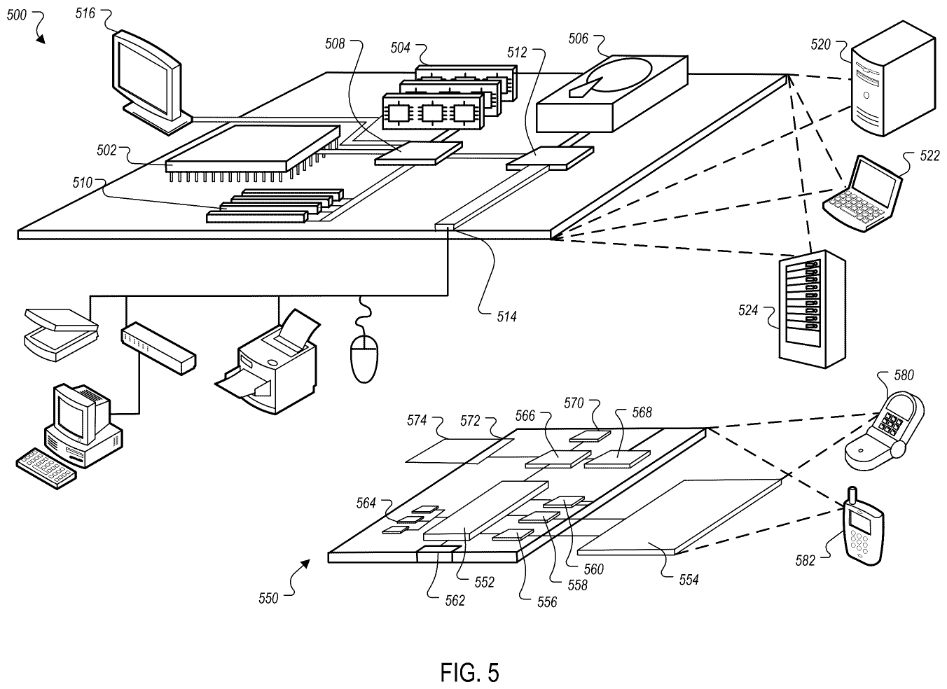

FIG. 5 is a block diagram of example computing devices 500, 550 that can be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 500 is further intended to represent any other typically non-mobile devices, such as televisions or other electronic devices with one or more processers embedded therein or attached thereto. Computing device 550 is intended to represent various forms of mobile devices, such as personal digital assistants, cellular telephones, smartphones, and other computing devices. The components shown here, their connections and relationships, and their functions, are meant to be examples only, and are not meant to limit implementations of the disclosures described and/or claimed in this document.

Computing device 500 includes a processor 502, memory 504, a storage device 506, a high-speed controller 508 connecting to memory 504 and high-speed expansion ports 510, and a low-speed controller 512 connecting to low-speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a graphical user interface (GUI) on an external input/output device, such as display 516 coupled to high-speed controller 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or memory on processor 502.

The high-speed controller 508 manages bandwidth-intensive operations for the computing device 500, while the low-speed controller 512 manages lower bandwidth-intensive operations. Such allocation of duties is an example only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed bus 514. The low-speed bus 514 (e.g., a low speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as computing device 550. Each of such devices may contain one or more of computing devices 500, 550, and an entire system may be made up of multiple computing devices 500, 550 communicating with each other.

Computing device 550 includes a processor 552, memory 564, an input/output device such as a display 554, a communication interface 576, and a transceiver 568, among other components. The computing device 550 may also be provided with a storage device, such as a micro-drive or other device, to provide additional storage. Each of the components 550, 552, 564, 554, 576, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the computing device 550, such as control of user interfaces, applications run by computing device 550, and wireless communication by computing device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of computing device 550 with other devices. External interface 562 may provide, for example, for wired communication (e.g., via a docking procedure) or for wireless communication (e.g., via Bluetooth® or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to computing device 550 through expansion interface 572, which may include, for example, a subscriber identification module (SIM) card interface. Such expansion memory 574 may provide extra storage space for computing device 550, or may also store applications or other information for computing device 550. Specifically, expansion memory 574 may include instructions to carry out or supplement the processes described above, and may include secure information also. Thus, for example, expansion memory 574 may be provide as a security module for computing device 550, and may be programmed with instructions that permit secure use of computing device 550. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Computing device 550 may communicate wirelessly through communication interface 576, which may include digital signal processing circuitry where necessary. Communication interface 576 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 568 (e.g., a radio-frequency transceiver). In addition, short-range communication may occur, such as using a Bluetooth®, WiFi, or other such transceiver (not shown). In addition, GPS receiver module 570 may provide additional wireless data to computing device 550, which may be used as appropriate by applications running on computing device 550.

Computing device 550 may also communicate audibly using audio codec 560, which may receive spoken information from a user and convert it to usable digital information. Audio codec 560 may likewise generate audible sound for a user, such as through a speaker, e.g., in a handset of computing device 550. Such sound may include sound from voice telephone calls, may include recorded sound (e.g., voice messages, music files, etc.) and may also include sound generated by applications operating on computing device 550.

The computing device 550 may be implemented in a number of different forms, as shown in the figure. For example, it may be implemented as a cellular telephone 580. It may also be implemented as part of a smartphone 582, personal digital assistant, or another mobile device.

In situations in which the systems discussed here collect personal information about users, or may make use of personal information, the users may be provided with an opportunity to control whether applications or features collect user information (e.g., information about a user's social network, social actions or activities, profession, a user's preferences, or a user's current location), or to control whether and/or how to receive content that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a user computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The term “traffic lane” is used herein to broadly include any type of lane (e.g., unpaved surface, sidewalk, crossings, pedestrian walks, road, street, highway, freeway, truckway, vehicle lane, bicycle lane, bus lane, tram lane, rail road, acceleration lane, merge lane, deceleration lane, turn lane, passing lane, climbing land, crawler lane, operational lane, auxiliary lane, ramp, shoulder, emergency lane, breakdown lane, transfer lane, express lane, collector lane, dedicated lane, carpool lane, toll lane, parking lane, fire lane, and slow lane) for a moving object to travel.

What is claimed is:

1. A method, comprising:
obtaining, by one or more processors and from a first sensor of a given vehicle, lane data specifying a lane of a multi-lane roadway that is occupied by the given vehicle;
obtaining, by the one or more processors and from a second sensor, vehicle passed data representing instances of the given vehicle being passed by other vehicles;
obtaining, by the one or more processors, travel data indicating that the given vehicle traveled a specified distance;
generating, by the one or more processors, an alert based on the lane data, the vehicle passed data, and the travel data; and
initiating, by the one or more processors, a lane change operation of the given vehicle based on the alert being generated.

2. The method of claim 1, further comprising determining, based on the vehicle passed data, a number of the other vehicles that passed the given vehicle while the given vehicle traveled the specified distance, wherein generating the alert comprises generating the alert when the number of other vehicles that passed the given vehicle while the given vehicle traveled the specified distance meets a threshold number.

3. The method of claim 2, wherein determining the number of other vehicles that passed the given vehicle while the given vehicle traveled the specified distance comprises:
obtaining blind spot data indicating that a blind spot monitoring system detected the other vehicles while the given vehicle traveled the specified distance;
obtaining additional data indicating that the other vehicles moved from a back of the given vehicle to a front of the vehicle while the given vehicle traveled the specified distance; and determining the number of other vehicles that passed the given vehicle based on the blind spot data and the additional data.

4. The method of claim 3, further comprising:
determining, based on the lane data, that the given vehicle is traveling in a designated passing lane over the given distance, wherein generating the alert data comprises generating the alert data based on (i) the given vehicle traveling in the designated passing lane over the given distance, and (ii) the number of vehicles that passed the given vehicle over the given distance meeting the threshold number.

5. The method of claim 4, wherein initiating the lane change operation of the given vehicle comprises illuminating a lane change indicator on a mirror of the given vehicle.

6. The method of claim 5, wherein initiating the lane change operation of the given vehicle further comprises autonomously navigating the given vehicle to a different lane of the multi-lane roadway.

7. The method of claim 1, further comprising:
generating, in a memory device, an alert log indicative of how many alerts have been generated for the given vehicle;
determining, based on the alert log, an alert trend indicating whether a frequency of alerts generated for the given vehicle have increased, decreased, or remained constant.

8. A system, comprising:
a first sensor configured to obtain lane data;
one or more computing devices configured to execute instructions that cause the one or more computing devices to perform operations including:
obtaining, from the first sensor of a given vehicle, the lane data specifying a lane of a multi-lane roadway that is occupied by the given vehicle;
obtaining, from a second sensor, vehicle passed data representing instances of the given vehicle being passed by other vehicles;
obtaining travel data indicating that the given vehicle traveled a specified distance;
generating an alert based on the lane data, the vehicle passed data, and the travel data; and
initiating a lane change operation of the given vehicle based on the alert being generated.

9. The system of claim 8, wherein the instructions cause the one or more computing devices to perform operations further comprising determining, based on the vehicle passed data, a number of the other vehicles that passed the given vehicle while the given vehicle traveled the specified distance, wherein generating the alert comprises generating the alert when the number of other vehicles that passed the given vehicle while the given vehicle traveled the specified distance meets a threshold number.

10. The system of claim 9, wherein determining the number of other vehicles that passed the given vehicle while the given vehicle traveled the specified distance comprises:
obtaining blind spot data indicating that a blind spot monitoring system detected the other vehicles while the given vehicle traveled the specified distance;
obtaining additional data indicating that the other vehicles moved from a back of the given vehicle to a front of the vehicle while the given vehicle traveled the specified distance; and determining the number of other vehicles that passed the given vehicle based on the blind spot data and the additional data.

11. The system of claim 10, wherein the instructions cause the one or more computing devices to perform operations further comprising:
determining, based on the lane data, that the given vehicle is traveling in a designated passing lane over the given distance, wherein generating the alert data comprises generating the alert data based on (i) the given vehicle traveling in the designated passing lane over the given distance, and (ii) the number of vehicles that passed the given vehicle over the given distance meeting the threshold number.

12. The system of claim 11, wherein initiating the lane change operation of the given vehicle comprises illuminating a lane change indicator on a mirror of the given vehicle.

13. The system of claim 12, wherein initiating the lane change operation of the given vehicle further comprises autonomously navigating the given vehicle to a different lane of the multi-lane roadway.

14. The system of claim 8, wherein the instructions cause the one or more computing devices to perform operations further comprising:
generating, in a memory device, an alert log indicative of how many alerts have been generated for the given vehicle;
determining, based on the alert log, an alert trend indicating whether a frequency of alerts generated for the given vehicle have increased, decreased, or remained constant.

15. A non-transitory computer readable medium storing instructions that, upon execution by one or more data processing apparatus, cause the one or more data processing apparatus to perform operations comprising:
obtaining, from a first sensor of a given vehicle, lane data specifying a lane of a multi-lane roadway that is occupied by the given vehicle;
obtaining, from a second sensor, vehicle passed data representing instances of the given vehicle being passed by other vehicles;
obtaining travel data indicating that the given vehicle traveled a specified distance;
generating an alert based on the lane data, the vehicle passed data, and the travel data; and
initiating a lane change operation of the given vehicle based on the alert being generated.

16. The non-transitory computer readable medium of claim 15, wherein the instructions cause the one or more data processing apparatus to perform operations further comprising determining, based on the vehicle passed data, a number of the other vehicles that passed the given vehicle while the given vehicle traveled the specified distance, wherein generating the alert comprises generating the alert when the number of other vehicles that passed the given vehicle while the given vehicle traveled the specified distance meets a threshold number.

17. The non-transitory computer readable medium of claim 16, wherein determining the number of other vehicles that passed the given vehicle while the given vehicle traveled the specified distance comprises:
obtaining blind spot data indicating that a blind spot monitoring system detected the other vehicles while the given vehicle traveled the specified distance;
obtaining additional data indicating that the other vehicles moved from a back of the given vehicle to a front of the vehicle while the given vehicle traveled the specified distance; and determining the number of other vehicles that passed the given vehicle based on the blind spot data and the additional data.

18. The non-transitory computer readable medium of claim 17, wherein the instructions cause the one or more data processing apparatus to perform operations further comprising:
determining, based on the lane data, that the given vehicle is traveling in a designated passing lane over the given distance, wherein generating the alert data comprises generating the alert data based on (i) the given vehicle traveling in the designated passing lane over the given distance, and (ii) the number of vehicles that passed the given vehicle over the given distance meeting the threshold number.

19. The non-transitory computer readable medium of claim 18, wherein initiating the lane change operation of the given vehicle comprises illuminating a lane change indicator on a mirror of the given vehicle.

20. The non-transitory computer readable medium of claim 19, wherein initiating the lane change operation of the given vehicle further comprises autonomously navigating the given vehicle to a different lane of the multi-lane roadway.

21. The non-transitory computer readable medium of claim 15, wherein the instructions cause the one or more computing devices to perform operations further comprising:
generating, in a memory device, an alert log indicative of how many alerts have been generated for the given vehicle;
determining, based on the alert log, an alert trend indicating whether a frequency of alerts generated for the given vehicle have increased, decreased, or remained constant.
